(19) United States
(12) Patent Application Publication
(10) Pub. No.: US 2014/0258056 A1
(43) Pub. Date: Sep. 11, 2014

(54) Method of Automatic Tax Transaction

(71) Applicant: ABBAS Ben Afshari, Lexington, KY (US)

(72) Inventor: ABBAS Ben Afshari, Lexington, KY (US)

(21) Appl. No.: 13/786,133

(22) Filed: Mar. 5, 2013

(51) Int. Cl. G06Q 40/00

(52) U.S. Cl. CPC G06Q 40/123
USPC 705/31

(57) ABSTRACT

A Method of transaction for payment of taxes electronically and interfacing between the sellers of goods and services and a fund depository account is introduced to ease the burden of manual check writing or manual payment transfer of taxes by a seller from a purchaser of good or service, the process is includes on time management of funds and easy and automated process of making all tax payment by using the current tax and banking infer structure, without spending extra time and effort to figure out the tax collected and tax returned manually

### OTHER REFERENCES

| | | |
|---|---|---|
| 5,987,429 | November 1999 | Maritzen et |
| | | al. |
| 6,078,899 | June 2000 | Francisco |
| | | et al. |
| 6,223,168 | April 2001 | McGurl et |
| | | al. |
| 6,411,938 | June 2002 | Gates et al. |
| 6,889,200 | May 2005 | Agee et al. |
| 6,983,261 | January 2006 | Francisco |
| | | et al. |
| 6,993,502 | January 2006 | Gryglewicz |
| | | et al. |
| 7,379,907 | May 2008 | Dang et al. |
| 2002/0111888 | August 2002 | Stanley et |
| | | al. |
| 2003/0040992 | February 2003 | Ryan et al. |
| 2003/0105686 | June 2003 | Dang et al. |
| 8,306,881 | NOVEMBER 2012 | Von Drehnen |
| | | et al. |
| 2012/13532776 | June 2012 | Afshari |

Search Report dated Jul. 29, 2002 for European Patent Application No. 02394054 (1 page). cited by other.

Communication and Examination Report dated Feb. 7, 2008 for European Patent Application No. 02394054.7-2221 (7 pages). cited by other.

Noting Loss of Rights dated Sep. 19, 2008 for European Patent Application No. 02394054.7-2221 (1 page). cited by other.

Declaration of Non-Establishment of International Search Report dated Jul. 24, 2003 for International Application No. PCT/EP 03/04584 (2 pages). cited by other.

Examination Report dated Mar. 11, 2010 for Canadian Patent Application No. 2,485,277 (5 pages). cited by other.

Examination Report dated Aug. 11, 2010 for Indian Patent Application No. 2725/CHENP/2004 (2 pages). cited by other.

http://www.window.state.tx.us/taxinfo/sales/webfile_sales.html

### BACKGROUND OF INVENTION

In today's business environment, businesses rely and depend on computers to make their business survive. In United States, The collecting and paying sales and use taxes are the duty of the seller. The seller must be aware of the sales and use tax in their state and county, upon selling a good or taxable service, collect the sales tax and pay the sales tax on time.

In addition to sales and use tax a corporation is mandated to pay other taxes, such as employment, city and local taxes.

With proper method of transaction thru a seller computer or at a remote location, seller could automate the tax paying process without relying on either an accountant managing the payments or manually do it themselves, manual could be snail mail or logging into a web site.

Often the seller has already spent the tax money and is not able to pay the tax to the tax authority on time. This results in unpaid taxes resulting in penalties and interests governed by the Tax authority.

Often sellers of goods must get their product back, due to defective merchandises or other reasons, hence reimburse the corresponding tax to the purchaser upon return, manually subtract the tax at the end of each tax payment period.

Often in USA businesses could make electronic tax filling and payment for most taxes, therefore the electronic filling capabilities and paying them with ACH transaction already exist. Collected sales taxes are filled electronically this means, an Electronic filer must log into a website which is designated by Tax authority, file their tax return and make their tax payment all manually.

Therefore there is a need to take the manual responsibility from the seller and automate the process, saving time by making tax return and payment an automatic computer transaction system driven process.

Meaning the system recognize a cycle and interactively check the bank account which is designated to make payments, file the tax return and pay the amount of tax without a single touch of an operator and after its original set up.

Therefore Present invention is a Method of transaction, which includes Total automation of tax payment process for a designated cycle. This method includes a transaction system to monitor the taxes collected, making it unavailable for the businesses to spend at the system level and pay the taxes on time automatically. The system could be set up for a seller with more than one bank account, one for the net and one for the tax.

The method of present invention includes a watch dog transaction system. The method, automatically tracks the sales and divide it into net plus Tax, while waits for a credit, debit and cash or check transaction completion, meaning that it monitors the bank account of the seller of goods and services interactively, and automatically interfaces with the website of the Tax authority, files the tax return and pays the tax, meanwhile requests the tax authority for confirmation of taxes paid, for a given cycle. Compiles the data and store it chronologically with dates, amounts of tax payments and corresponding confirmations from tax authority.

The transaction system mandates the business establishment to choose at least one cycle for payment of taxes. This cycle depends on the tax authority Electronic filling rules and regulations. The seller upon using the transaction system of present invention must choose at least one of the available tax reporting and paying cycles, which could be, day, week, month, quarter year or some other cycle.

In case of federal excise taxes. The transaction system recognizes the rules of federal government and the tax rate of the taxable item. And make proper calculation, reporting and paying of Federal excise taxes. Hence the tax filling and payment becomes transparent for the business establishment or the seller of good or service,

This method is Novel, since it makes the responsibility of tax paying automated for each cycle of tax reporting and payment.

Sometimes purchasers purchase goods or service thru Internet, the present Method recognizes the internet transactions and the state that taxes must be collected for, and make automatic tax payment transactions, while a third party which is offering a service to a seller collects the funds, deducts the taxes, deduct their fees based on negotiated percentage of sales between third party and the seller and pays the seller. File the taxes, and pay the taxes for the seller and for themselves.

In a case of a return of goods or service, the tax becomes a negative number and gets reported as negative sales.

The method of present invention could be set to work with available accounting software or Stand Alone.

Often purchaser use a smart phone to purchase goods, since this transaction carried out thru internet, The method and transaction system of present invention recognizes the state in which the tax must be mandated and automatically performs the tax calculation and tax payment.

Sometimes the seller of the goods or services prefers to access the transaction system of present invention in a remote location. In This case the tax is still paid automatically by the sellers from their bank account, but the transaction system of present invention is located at a central location and not the computer of the seller.

Since the present invention is a method to mandate an automatic tax payment, The method applies to business establishments that must make several different tax payments, which may includes a sales tax, unemployment tax, excise tax, etc. The present method is capable of making automatic calculation of taxes and automatic payment of taxes without manual work for the corporation employees. Once the transaction system installed it monitors available funds and mandates the usage of funds to be total funds less taxes, and make the tax payment on time at a preset cycle.

### Prior Art

Some prior arts require a third party to get involved in determination of tax amount or approval of the fund transfer, some must calculate the tax amount. Non of prior art indicates mandating the usage of amount of funds in a particular bank account, and automatic tax payment from the bank account of a seller of goods or a corporation subject to certain taxes. And non takes cycle time of tax reporting and paying under consideration.

In prior art, patent 8306881 a settlement agency server is involved which is a third party and a settlement agency server determines and calculates the tax. And transfers the tax. Substantial simultaneous tax and cost of goods payment by the settlement agency and an instantaneous notification of such tax by the settlement agency to tax authorities; the settlement agency pays the seller and the tax authority, therefore the settlement agency or merchant accounts and not the seller are responsible. In most storage system it is not possible to make instantaneous taxes for each transaction since it overloads the communications pipeline. Meanwhile a sales tax must be 1st collected by a seller before they could make a tax report and tax payment

In another case, U.S. Pat. No. 7,379,907 is identifying a method to report taxes to a financial institution, and manually pay these taxes by logging into a website belonging to tax authority, the transaction system still must be managed by a user and doesn't have interactive capability with a sellers bank and doesn't mandate the usage of available funds in the bank account of the seller or automate the process of making tax payment, the seller or the accountant of the seller manually make all transactions thru the website. Although the prior art includes an automatic tax payment method this automation only excludes present of paper and still requires an individual manually logging into a website to make the report and transmit the report to tax authority. It doesn't have capability of mandating available funds from a bank account at its level.

Enclosed invention includes 100% automation of tax paying and tax reporting for a preset period of cycle time, and allowing for automatic payment of taxes without changing the Bank or Tax authority infer structure.

While it is the duty of the seller to collect the sales tax and pay the sales tax, the enclosed invention does this process in automation, smoothly and effectively. Collect taxes and pay them on time and manage spending the funds that must be designated to pay for taxes.

Therefore It is the intention of this invention to create a method, which includes a transaction system to automatically calculate and pay different type of taxes, on time, paperless and without the manual work of an individual. Hence saves Time and money.

### BRIEF DESCRIPTION OF THE DRAWINGS

The foregoing summary, as well as the following detailed description of the illustrated diagram is better understood when read in conjunction with the appended diagrams. For the purpose of illustrating the invention, there is shown in the diagrams several exemplary method which illustrate what is currently considered to be the best mode for carrying out the invention, it being understood, however, that the invention is not limited to the enclosed specific methods and instruments disclosed in the diagrams.

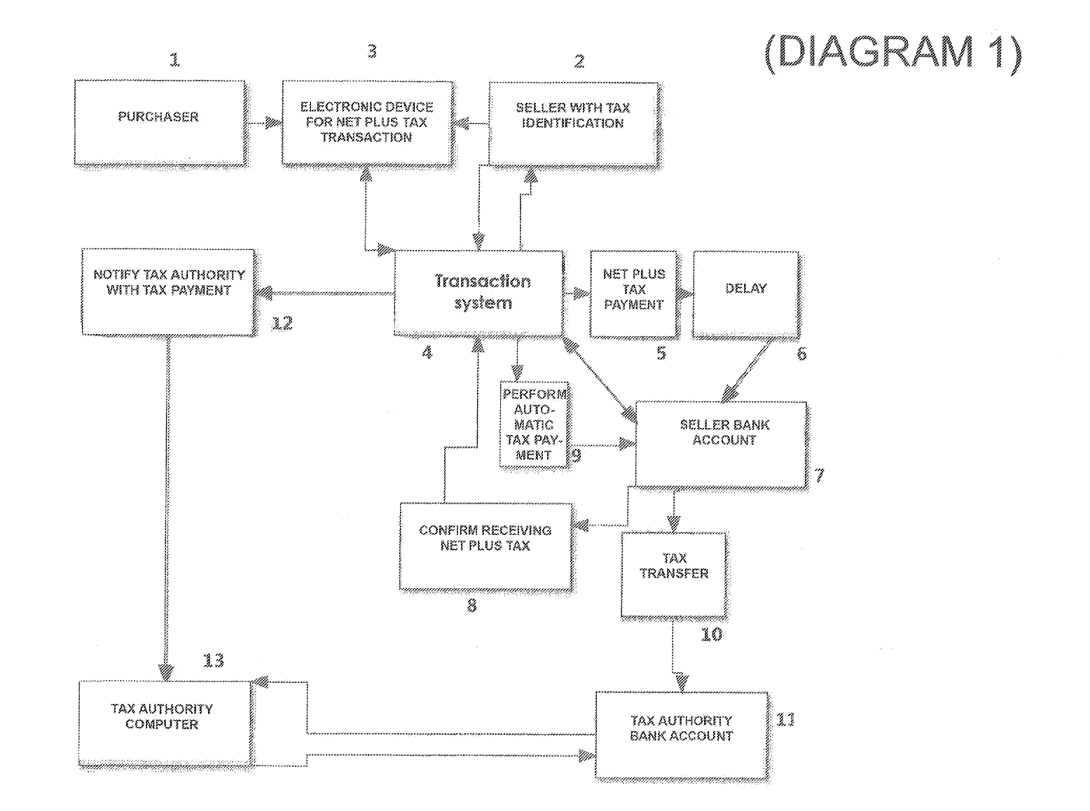

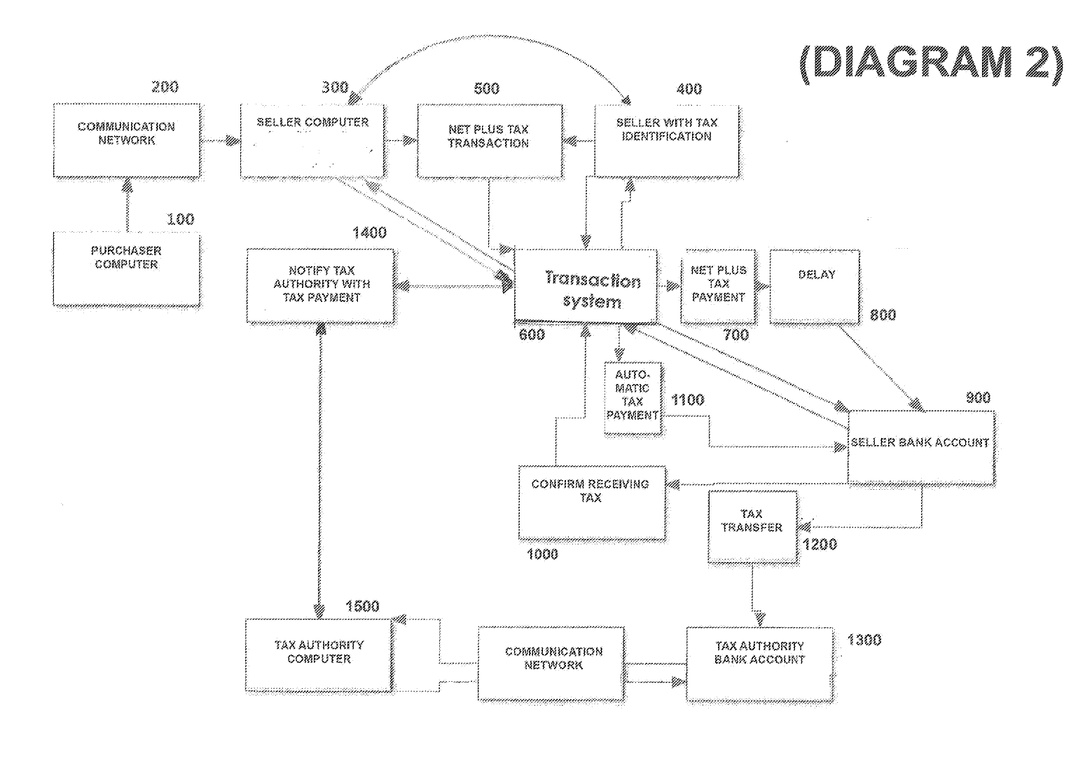

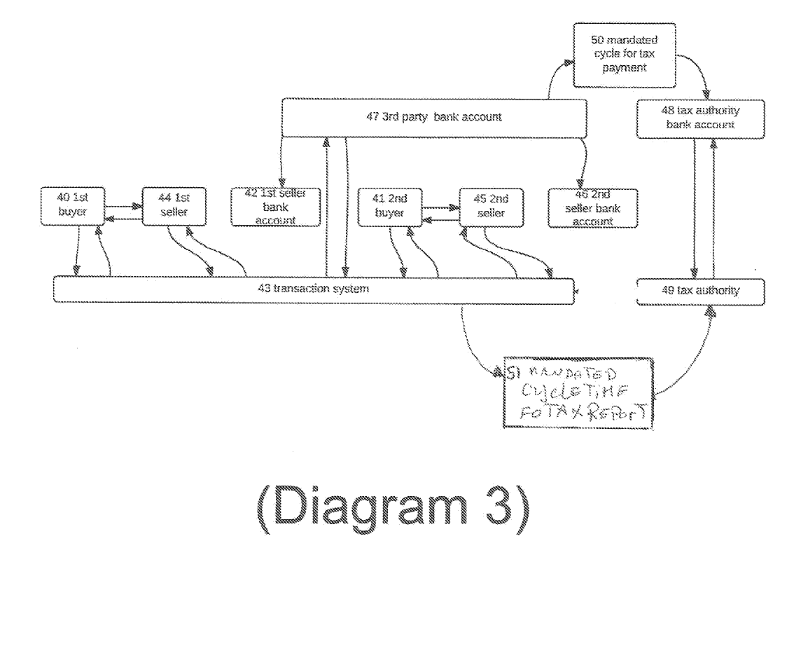

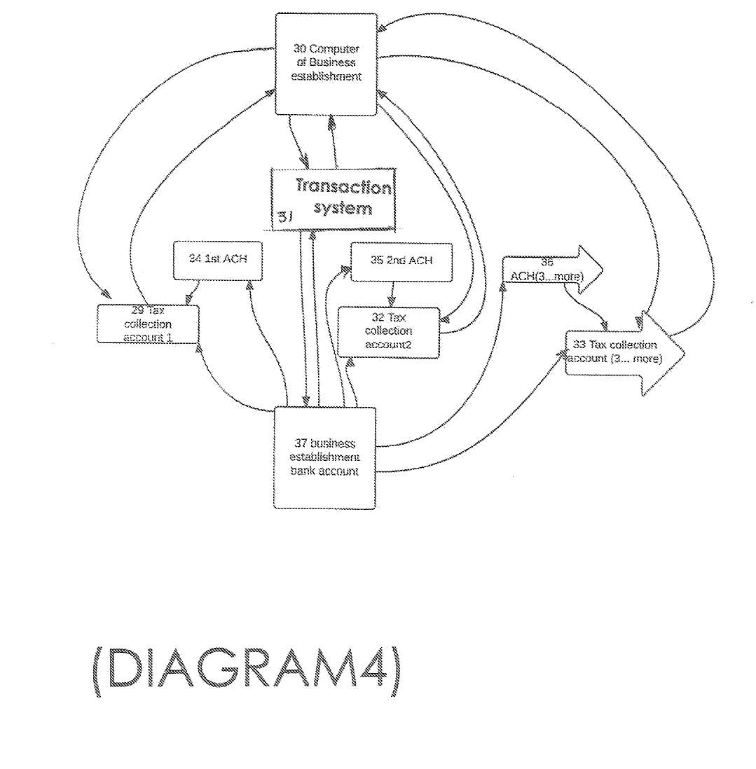

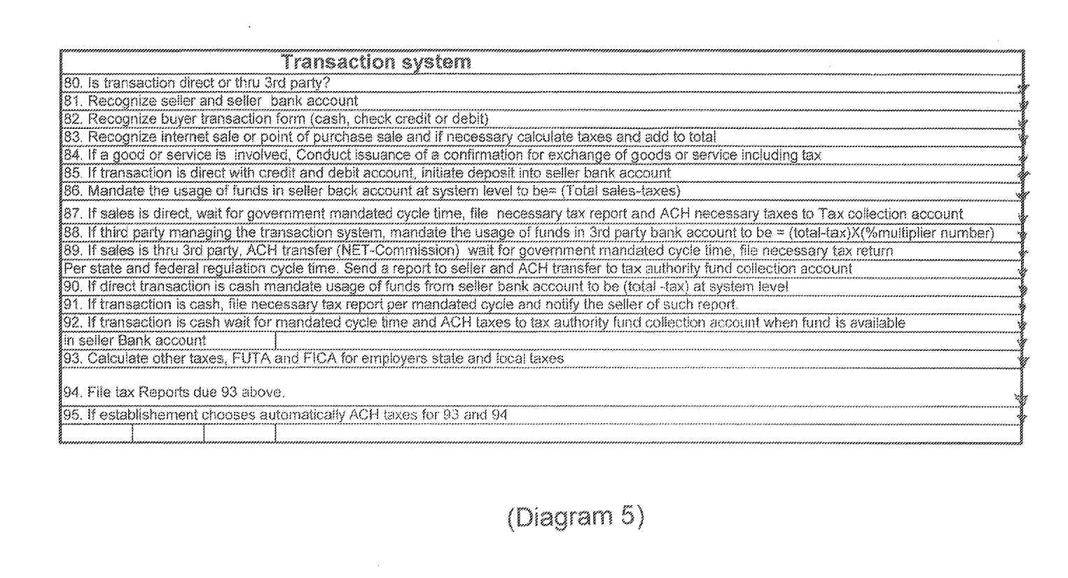

The diagram of FIGS. 1, 2 and 3 and 4 and 5 demonstrates examples of present invention without limiting other possibilities thereof.

### DIAGRAM 1

is a method of present invention

Purchaser 1, start making a transaction 3 with seller 2. Seller 2 uses electronic device 3 to interface with transaction system 4 and transaction system 4 conducts the transaction 3 and communicates it with the electronic device 3 for the net plus transaction 3. While there are always a delay 6 for net plus tax payment 5 the transaction system 4 monitors the transaction 4 and recognizes the delay 6 for fund transfer from the purchaser 1 credit or debit account to the seller bank account 7. The transaction system 4 in use by the seller 2 acts as a watch dog to confirm receiving net plus tax 8 with the delay 6 and confirm receiving net plus tax 8 in the bank account 7, the transaction system 4 performs automatic command to tax transfer 10 from bank account 7 to tax authority bank account 11, transaction system 4 notifies tax authority computer 13 with tax payment 12 to tax authority computer 13. The process could expose to that

### DIAGRAM 2

is another method of present invention:

Where purchaser computer 100 uses network 200 to make a purchase of good or service using his credit or debit account which includes a net plus tax transaction 500 and transmit the purchase action to seller computer 300 which is equipped with transaction system 600 and, seller 400 accept the net plus tax transaction 500. Transaction system 600 recognizes net plus tax payment 700. And the delay 800 and the transfer of fund into sellers bank account 900 Transaction system 600 which is interfacing with seller computer 300 confirms receiving tax plus net transaction 500 to include tax plus net transaction 500 and time delay 800 and initiate at least one code to tax transfer 1200 to tax authority 1300, transaction system 600 notify tax authority with tax payment 1400 to tax authority computer 1500.

### DIAGRAM 3

Represents to when a 3^{rd} party is an agency that is hired by the seller to assist the seller with advertising, marketing and selling thru internet, in this case, buyer 40 purchases a product from seller 44 and a buyer 41 purchases a product from seller 45. The funds for transactions gets collected at a 3^{rd} party bank account 47, which is managed by transaction system 43. Then transaction system 43, deducts the tax and their commission from total transaction and ACH the amount to seller Bank account 42 and seller bank account 46, and report the tax based on mandated cycle time 51 and send a copy to computers 1st seller 44 and 2^{nd} seller 45 and make Ach transaction from their bank account 47 based on mandated payment cycle time corresponding to tax report 50 to the tax authority bank account or fund collection account 48.

### DIAGRAM 4

is another method of present invention:

Computer 30 communicates with transaction system 31 which interactively controls the activity of bank account 37 thru communication networks and only commits the usage of bank account 37 to total funds minus taxes and conducts several ACH transaction orders 34, 35 and 36 and if necessary more, to transfer funds to tax collection account 29, 32, 33 and if necessary more.

### DIAGRAM 5

Is another method of present invention

Where the there are options to expand the transaction system to monitor other than sales and use tax. In a sentence format.

I claim:

1. A method of transaction comprising:
At least one seller selling at least one good or service subject to at least one tax, governed by tax authority of at least one government. Said seller controls at least one Bank account and at least one electronic device. At least one purchaser, said purchaser purchasing the at least one good or service using a credit or debit account. At least one tax amount plus at least one net amount charged to said credit or debit account for to the sale of at least one good or service, from the at least one purchaser by the at least one seller. Said at least one seller identified by at least one tax Identification assigned by said tax authority. Said at least one tax authority in control or possession of at least one fund collection account and 1st computer. Said 1^{st} computer and said electronic device, connected to the same communication network. Said transaction conducted thru said at least one electronic device, said electronic device interfacing with at least one Transaction system, said at least one Transaction system interactively tracking the said credit or debit account purchase transaction which includes the at least one tax amount plus the at least one net amount. Said at least one net amount plus the said at least one tax amount deposit with a time delay into said at least one bank account, said transaction system mandate automatic fund transfer of said at least one tax amount from the at least one bank account to the said at least one tax collection account. And perform at least one code to authorize transfer of the said at least one tax amount from the said at least one bank account to the said at least one fund collection account in possession or control of said tax authority.
Said Transaction system includes a 2^{nd} computer at the location of at least one seller

3. Transaction system of claim 1 automatically sends at least one code to said 2^{nd} computer to notify the said at least one seller prior to sending said tax report to said 1^{st} computer.

4. The Transaction system of claim 1 interactive with said bank account, said Transaction system mandate availability of funds from the at least one seller bank account, Said mandate are for funds remaining less tax amount.

5. Tax amount of claim 1 corresponds to a positive or a negative number.

6. The Transaction system of claim 1 includes a computer at a remote location from said seller. And accessible by a network.

7. The fund transfer of claim 1 is an ACH transaction.

8. The at least one electronic device of claim 1 is a device for swiping a credit card or a debit card.

9. The at least one electronic device of claim 1 is a computer

10. The purchaser of claim 1 initiate the said purchase using a hand held mobile device equipped with Global positioning software.

11. The fund transfer of claim 1 is conducted for each or sum of more than 1 transactions.

12. The fund transfer of claim 1 conducted for a predetermined cycle, where Said cycle mandated by said tax authority.

13. Transaction system of claim 1 automatically sends at least 1 code to said 1^{st} computer corresponding to said at least one tax prior to said at least one fund transfer thru said network.

14. A method of transaction comprising:
At least one seller selling at least one good or service subject to at least one tax, governed by a tax authority. Said at least one seller controls or possess at least one Bank account, and at least one purchaser purchasing at least one good or service subject to a net plus tax from the at least one seller using cash for the purchase of said at least one good or service. Said at least one seller identified by at least one tax Identification assigned by said tax authority. Said at least one tax authority in control or possession of at least one fund collection account. Said transaction conducted thru at least one electronic device connected to a communication network via at least one wired or at least one wireless system. And Said at least one electronic device interfacing with at least one Transaction system, said at least one Transaction system interactively monitoring credit and debit activity of said at least one bank account in control or possession of said at least one seller. Said at least one Transaction system monitor the fund availability for said at least one tax amount from the said at least one bank account, said Transaction system automatically transfer said at least one tax amount to the said fund collection account in control or possession of said at least one tax authority.

15. Fund Transfer for said at least one tax amount of claim 14 is an ACH transaction.

16. A method of making tax payment comprising:
A business establishment subject to making at least one tax payment to at least one tax authority, said at least one tax authority in control of at least one fund collection account and accept incoming ACH transactions. Said business establishment in control of at least one bank account and at least one computer, said computer capable of interfacing with at least one Transaction system, said Transaction system calculates the said at least one tax amount, said computer connected to internet. Said Transaction system interactively monitor the activity of said bank account, said Transaction system mandate the usage of available funds in said bank account when monitored at said computer, said usage is less said at least one tax, said transaction system automatically conduct initiation of ACH transactions to transfer said at least one tax amount to said at least one fund collection account in control of said at least one tax authority.

17. A method of transaction comprising;
1st buyer and at least 2nd buyer, each with a Electronic device having micro processor and memory connected to a network and a transaction system in control of a third party, and 1^{st} and at least 2^{nd} credit or debit account, and 1st seller and at least 2nd seller each having at least 1 tax identification, and at least one computer connected to said network and at least one bank account. Each of the 1st and at least 2^{nd} seller offering at least one product or service for sale on the said network said offer only accessed from said electronic device, said at least one tax identification assigned by at least one tax authority in control of at least 1 computer connected to said network and at least one fund collection account, said third party in control of said access and at least one bank account, said 1st and at least 2^{nd} buyers each purchase the said at least one product or service from the 1st and at least 2^{nd} seller, using the said 1^{st} and at least 2^{nd} credit or debit account by initiating the purchase by said each electronic device, Said each purchase includes 1 net and 1 tax. Said Transaction system automatically deposits the funds from the 1^{st} and at least 2^{nd} credit or debit account transaction in the at least one bank account in possession or control of said 3^{rd} party, said transaction system mandate the usage of said funds in said bank account for each transaction to {[((total of 1^{st} and least 2^{nd deposit))}−(total of 1^{st} and at least 2^{nd} tax))×(y %))]=1^{st} commission and at least 2^{nd} commission} where 1^{st} commission and 2^{nd} commission are service fees from said seller to said third party and the y % is a multiplier to calculate said commission. fees that third party charges to the 1^{st} and at least 2^{nd} seller, and automatically initiates making at least 3 ACH transaction from 3rtd party Bank account to one transaction correspond for the [(1^{st} net)−(1^{st} commission)] amount to the 1^{st} seller bank account, at least one transaction for the [(at least 2^{nd} net)−(at least 2^{nd} commission) amount to the at least 2^{nd} seller bank account. And one transaction for at least one cycle mandated by the tax authority for total of 1^{st} and at least 2^{nd} tax amount to said at least one tax authority fund collection account. Said at least one Transaction system, sends a report to said each seller 1^{st} and at least 2nd computers corresponding to said 1^{st} and at least 2^{nd} ACH transaction for taxes and fund transferred paid corresponding to said period.

17. Transaction system of claim 16 automatically sends at least 1 code to said 1^{st} computer corresponding to said at least one tax identification prior to said at least one fund transfer thru said network.

17. The electronic device of claim 16 is a smart phone equipped with Global positioning software.

18. The electronic device of claim 16 is a computer.
